(19) United States
(12) Patent Application Publication
(10) Pub. No.: US 2005/0028382 A1
(43) Pub. Date: Feb. 10, 2005

(54) Portable brushcutter

(75) Inventors: Shunsuke Nakadate, Tokyo (JP); Tomoko Kuse, Tokyo (JP)

Correspondence Address: NIXON PEABODY, LLP, 401 9TH STREET, NW, SUITE 900, WASHINGTON, DC, 20004-2128, US

(73) Assignee: KIORITZ CORPORATION, Tokyo (JP)

(21) Appl. No.: 10/902,845

(22) Filed: Aug. 2, 2004

(30) Foreign Application Priority Data
Aug. 8, 2003 (JP) 2003-290528

(51) Int. Cl. B26B 7/00

(52) U.S. Cl. 30/276

(57) ABSTRACT

The present invention is directed to a portable brushcutter, which comprises a hollow tubular operating rod having a front end provided with a cutting bade and a rear end provided with a drive unit. An output shaft extends longitudinally within the operating rod to transmit a driving force from the drive unit to the cutting blade. Four or more bushings each having an elastic member are disposed in the operating rod while being longitudinally spaced apart from each other, to support the output shaft. A liner is provided to extend within the rod. The liner has a through-hole extending along the axis thereof to allow the output shaft to pass therethrough, and a radially outermost periphery formed as a plurality of strip-shaped faces circumferentially spaced apart from each other. The present invention can provide a portable brushcutter having excellent anti-vibration effect, high strength and sufficiently reduced weight.

### FIELD OF THE INVENTION

The present invention relates to a portable brushcutter for cutting or trimming grasses, weeds or the like, and more particularly to a portable brushcutter having an operating rod with excellent anti-vibration effect and high impact resistance.

### BACKGROUND ART

A conventional portable brushcutter is typically provided with a hollow tubular operating rod which has a front end provided with a rotary cutting blade, and a rear end provided with a drive unit, such as a two-stroke engine. An output shaft for transmitting a driving force from the drive unit to the cutting blade is disposed in the hollow space of the operating rod to extend in the longitudinal direction of the operating rod. The output shaft is rotatably supported by a plurality of bushings disposed on the inner surface of the operating rod while being spaced apart from each other in the longitudinal direction of the operating rod.

A handle member is provided at an intermediate position of the outer surface of the operating rod to allow an operator to manipulate the portable brushcutter by gripping the handle member. Generally, vibration of the handle member, transmitted from the cutting blade rotationally driven by the drive unit, is likely to make the operator feel uncomfortable. In order to prevent such vibration from occurring in the handle member, the portable brushcutter has been designed to have a liner in the operating rod.

For example, Japanese Patent Publication No. 2904767 discloses a grass cutter comprising an outer tube, a flexible shaft liner inserted into the outer tube over its entire length, and a flexible shaft inserted into the flexible shaft liner. The flexible shaft liner disclosed in the above publication is formed in a shape which is not directly brought into contact with the inner surface of the outer tube. Further, a plurality of rubber vibration insulators are disposed, spaced apart from each other, on the outer surface of the flexible shaft liner extending over the entire length of the outer tube, and the respective outer surfaces of the rubber vibration insulators are brought into contact with the inner surface of the outer tube. In this manner, vibrations of the flexible shaft are prevented from being transmitted to the outer tube.

Japanese Utility Model Publication No. 60-38341 also discloses a brushcutter in which a shaft-receiving member, having a plurality of protrusions to be fitted onto the inner surface of a connection rod, is provided in the inner space of the connection rod to extend approximately over the entire length of the connection rod. This shaft-receiving member prevents the occurrence of sympathetic vibration in a power transmission shaft and damage to a power transmission mechanism. As with the Japanese Utility Model Publication No. 60-38341, Japanese Patent Publication Nos. 2927556 and 3103044 and Japanese Utility Model Laid-Open Publication Nos. 60-185424 and 56-153133 disclose techniques for preventing vibration transmission using a liner disposed in the inner space of an outer tube to extend approximately over the entire length of the outer tube.

As described above, in portable brushcutters, the vibration control of the operating rod is important in preventing vibration transmission to the handle member. Further, if the operating rod is broken off or largely bent during a cutting operation due to striking a tree trunk or the like, such a damaged operating rod will likely cause difficulties in keeping the operation going. Thus, the operating rod should be designed to have a sufficient strength. Furthermore, weight reduction is another key factor because the portable brushcutter is originally manipulated in a hand-held manner by an operator.

### SUMMARY OF THE INVENTION

In view of the above, it is therefore an object of the present invention to provide a portable brushcutter having excellent anti-vibration effect, high strength and sufficiently reduced weight.

In order to achieve the above object, the present invention provides a portable brushcutter comprising: a cutting blade, a drive unit, a hollow tubular operating rod having a front end provided with the cutting bade, and a rear end provided with the drive unit, an output shaft disposed in the hollow space of the operating rod to extend in the longitudinal direction of the operating rod, and adapted to transmit a driving force from the drive unit to the cutting blade, and four or more bushings each having an elastic member. The bushings are disposed in the hollow space of the operating rod while being spaced apart from each other in the longitudinal direction of the operating rod, to support the output shaft. The bushings are located, respectively, at the boundaries between adjacent ones of a plurality of zones defined by dividing the hollow space of the operating rod in the longitudinal direction from the side of the drive unit to the side of the cutting blade. The portable brushcutter further includes a liner extending within only one or more of the zones located on the side of the cutting blade. The liner is formed with a through-hole extending along the axis thereof to allow the output shaft to pass therethrough. The liner has a radially outermost periphery formed as a plurality of strip-shaped faces circumferentially spaced apart from each other. Each of the strip-shaped faces extends in the longitudinal direction of the operating rod while being in contact with the inner surface of the operating rod.

The portable brushcutter of the present invention enables the plurality of bushings and the liner to cooperatively prevent vibration transmission arid vibration noises. In addition, the liner disposed in the operating rod on the side of the cutting blade allows the region of the manipulation liable to be hit against a tree trunk or the like to have an increased strength so as to provide an improved portable brushcutter with high impact resistance. Furthermore, according to the present invention, the liner disposed only in a part of the hollow space of the operating rod can achieve a portable brushcutter capable of obtaining excellent anti-vibration effect and high strength in a more lightweight structure as compared to that of the conventional portable brushcutter. That is, the present invention can provide sufficient resistibility to deformation due to shocks or impacts, to a portable brushcutter even if it has a lightweight operating rod.

In one further embodiment of the present invention, the liner may extend along the entire range of the zone closest to the cutting blade. This structure can provide a portable brushcutter having a higher anti-vibration effect.

In a further preferred embodiment of the present invention, the liner may extend along both the zone closest to the cutting blade and the zone adjacent to the zone closest to the cutting blade. This structure can provide a portable brushcutter having a much higher anti-vibration effect.

In still a further preferred embodiment of the present invention, the number of the bushings may be five. This structure allows a portable brushcutter to assure sufficiently enhanced anti-vibration effect.

Other features and advantages of the present invention will be apparent from the accompanying drawings and from the detailed description.

### BRIEF DESCRIPTION OF THE DRAWINGS

FIG. 1 is a general view showing a portable brushcutter according to one exemplary embodiment of the present invention.

FIGS. 2(a) to 2(c) are longitudinal sectional views showing the respective internal structures of Comparative Examples 1 to 3 of an operating rod.

FIGS. 2(d) to 2(f) are longitudinal sectional views showing the respective internal structures of Comparative Example 4 and Inventive Examples 3 and 1 of an operating rod.

FIGS. 2(g) and 2(h) are longitudinal sectional views showing the respective internal structures of Inventive Examples 2 and 4 of an operating rod.

FIGS. 3(a) and 3(b) are enlarged views showing a bushing corresponding to the area surrounded by the chain line in FIGS. 2(d), 2(f), 2(g) and 2(h), and a liner stopper corresponding to the area surrounded by the chain line in FIGS. 2(b), 2(c) and 2(e), respectively.

FIG. 4 is an enlarged cross-sectional view taken along the line IV-IV in FIGS. 2(b) to 2(h).

FIG. 5 is a table showing results of vibration/vibration noise tests.

FIG. 6 is a table showing results of an impact test.

FIG. 7 is a graph of the test result in FIG. 6, which shows the relationship between an impact value J and a deformation angle (permanent bent angle) of an operating rod.

FIG. 8 is an enlarged cross-sectional view showing one modification of a liner in a portable brushcutter of the present invention.

FIG. 9 is an enlarged cross-sectional view showing another modification of the liner.

FIG. 10 is an enlarged cross-sectional view showing still another modification of the liner.

### DESCRIPTION OF THE PREFERRED EMBODIMENTS

With reference to the accompanying drawings, an exemplary embodiment of the present invention will now be described in connection with various examples.

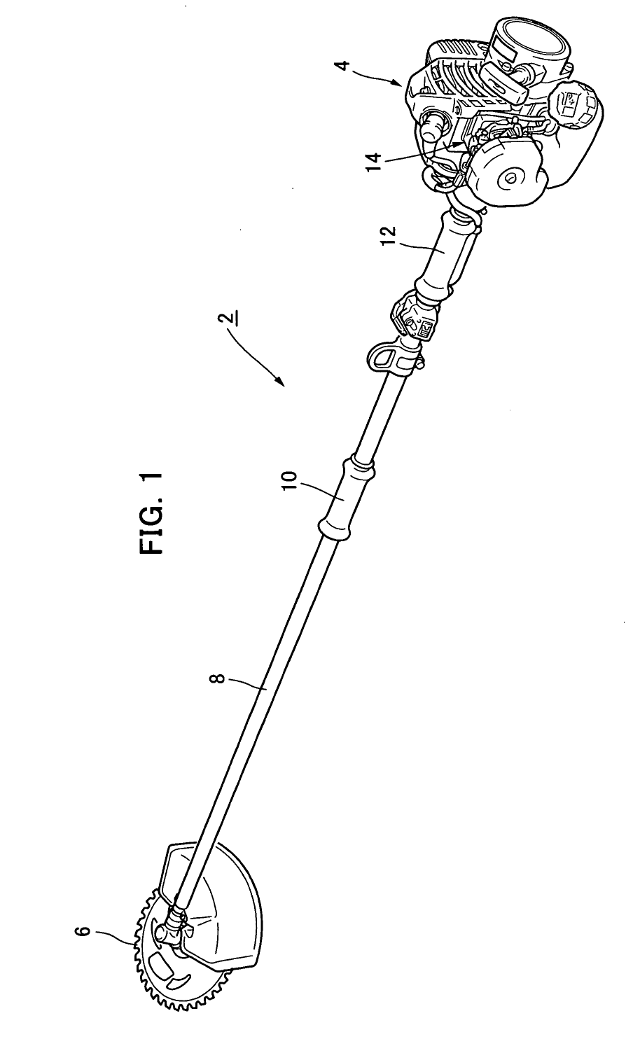

FIG. 1 is a general view of a portable brushcutter according to one embodiment of the present invention.

As shown in FIG. 1, a portable brushcutter 2 according to this embodiment comprises a drive unit 4 attached at the rear end of the brushcutter 2, a circular cutting blade 6 rotatably attached at the front end of the brushcutter 2, a hollow tubular operating rod 8 linearly extending between the drive unit 4 and the cutting blade 6, a cutting-blade-side grip 10 (left-hand grip) provided at an intermediate position of the operating rod 8, and a drive-unit-side grip 12 (right-hand grip). The drive unit 4 includes an internal combustion engine 14 composed of a small-size air-cooled 2 or 4-stroke gasoline engine. The portable brushcutter 2 further includes an output shaft 16 disposed in the hollow space of the operating rod 8 to extend in the longitudinal direction of the operating rod 8, and adapted to transmit a driving force from the drive unit 4, specifically the rotation of a crankshaft (not shown) of the internal combustion engine 14, to the cutting blade 6 through a centrifugal clutch (not shown).

### 1. VIBRATION/VIBRATION NOISE TESTS

### 1-1. Structure of Tested Operating Rod

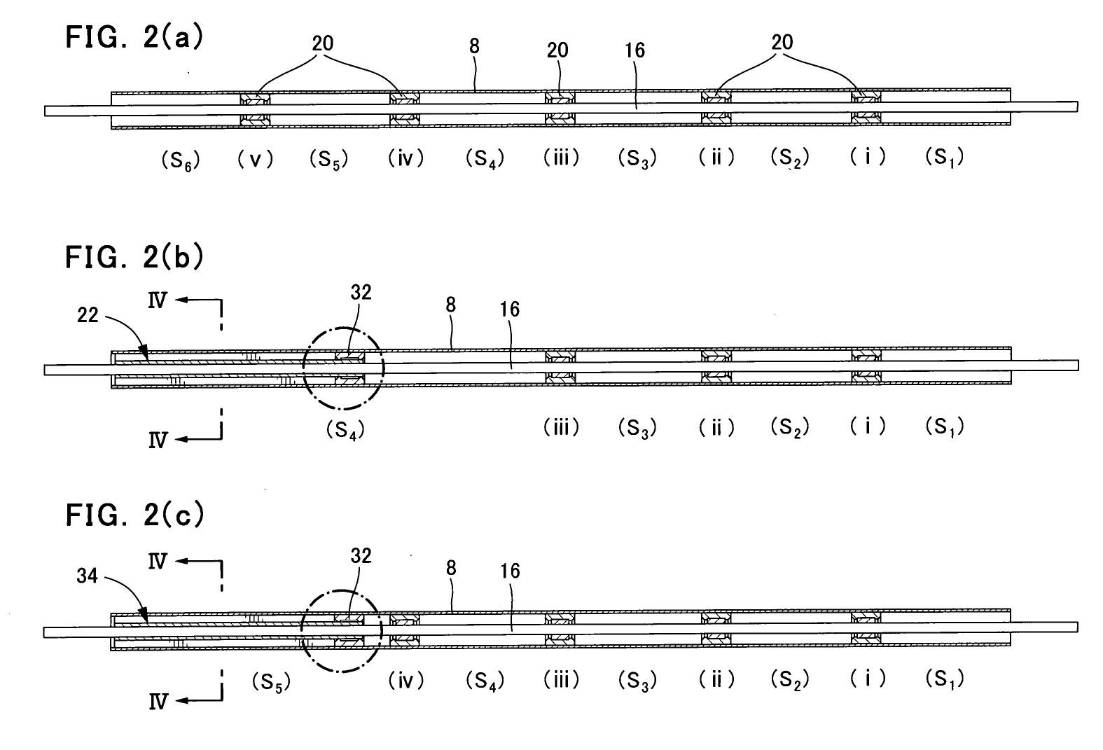

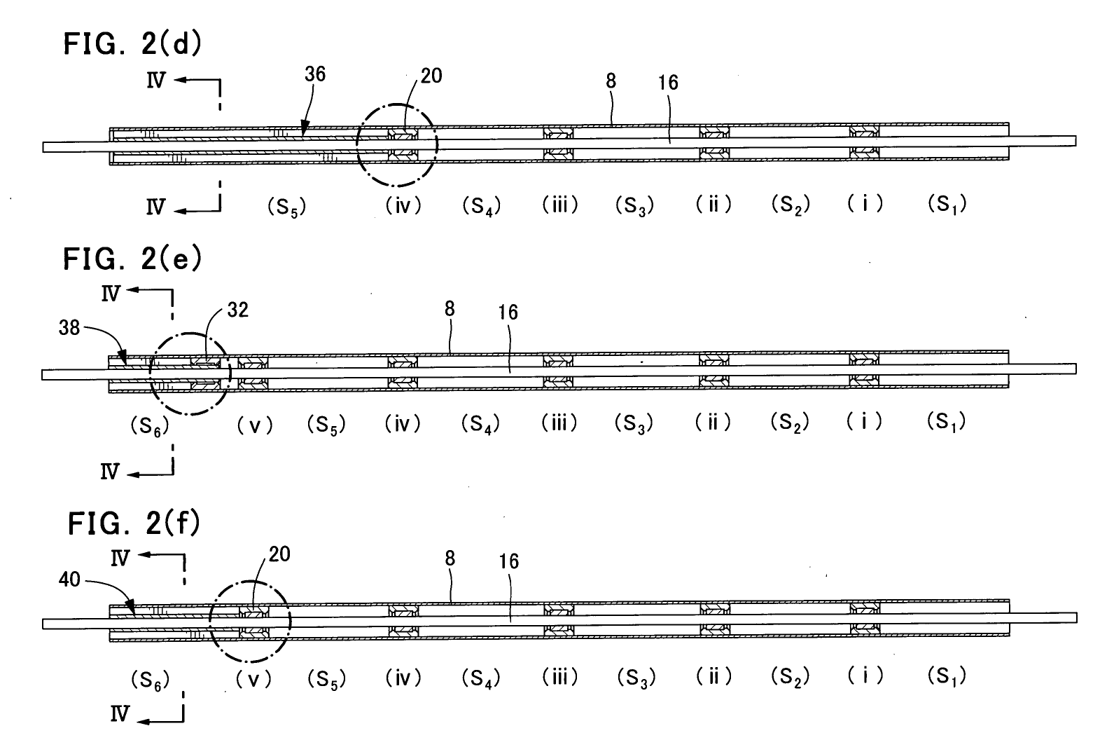

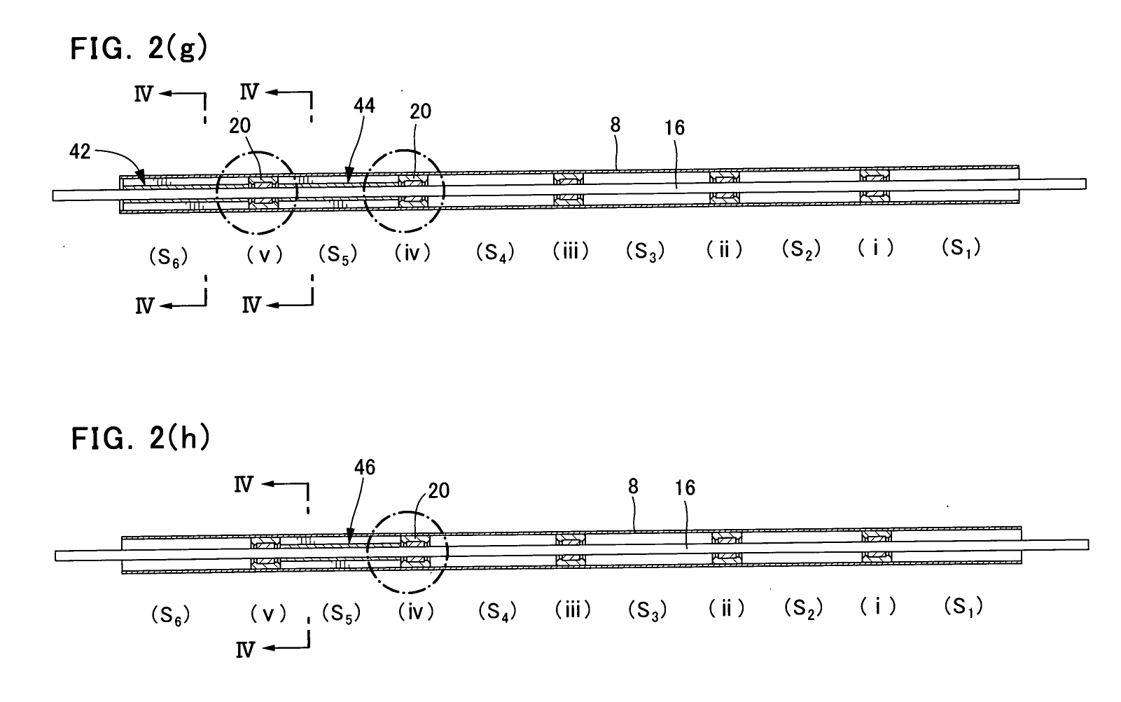

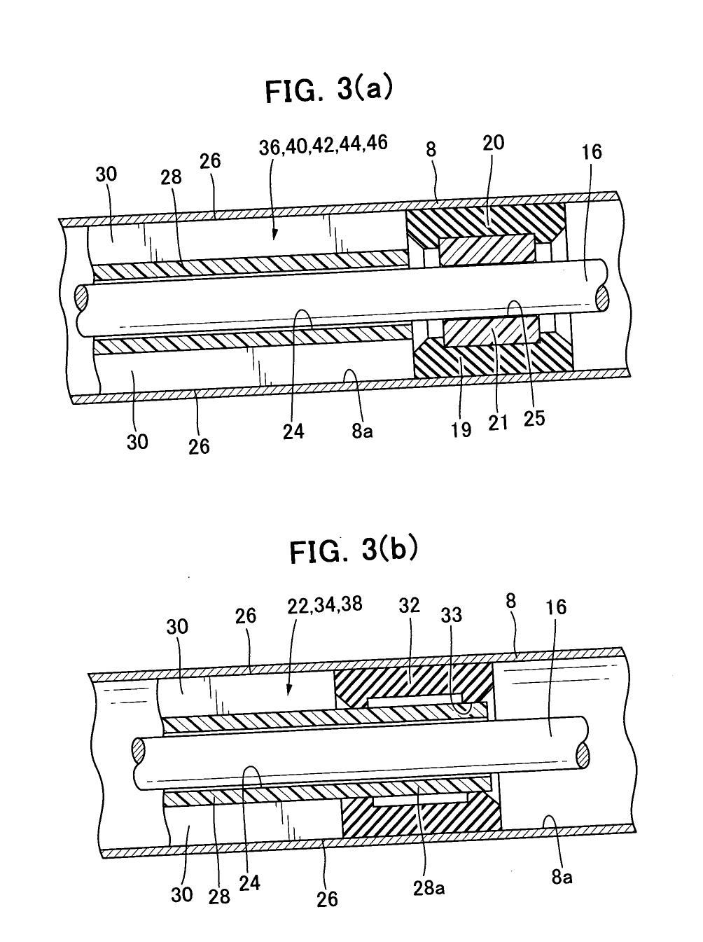

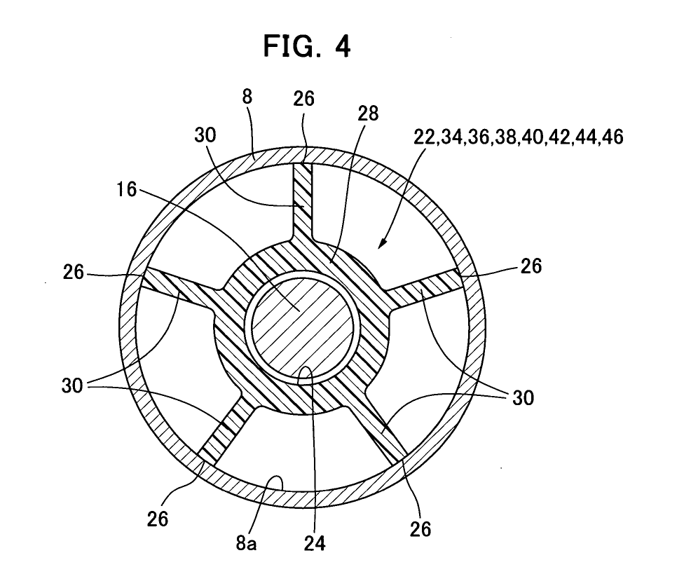

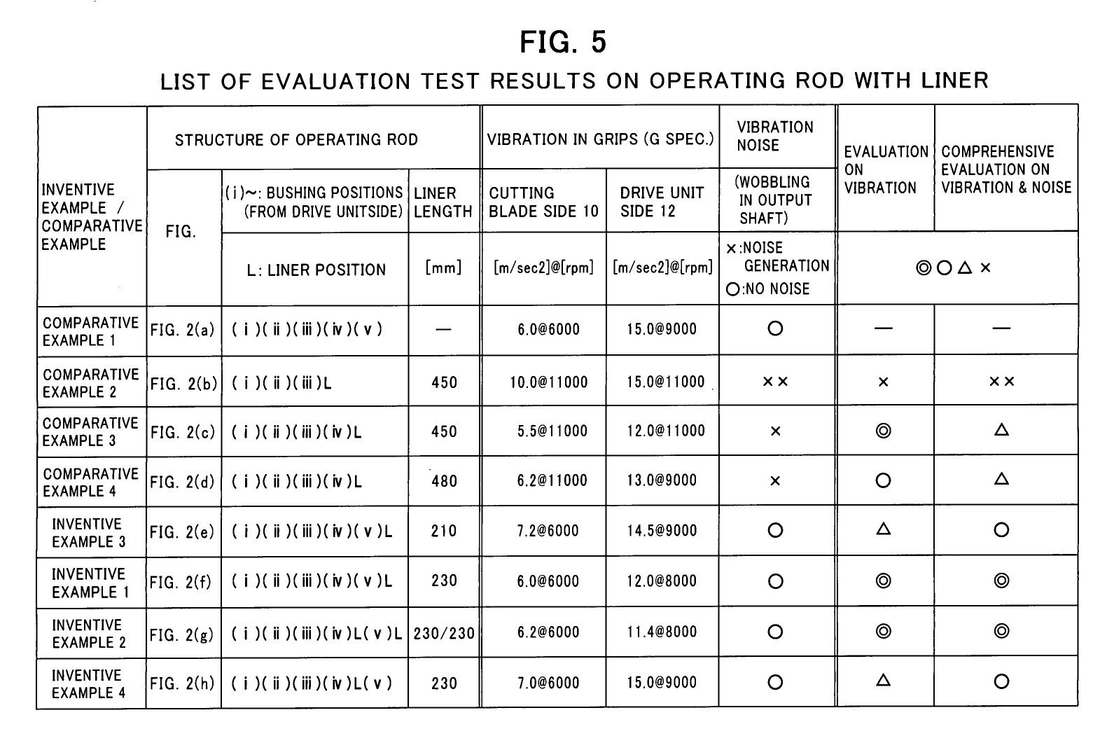

FIGS. 2(a) to 2(h) are longitudinal sectional views of eight types of operating rods, each having a different internal structure. FIGS. 3(a) and 3(b) are enlarged views showing a bushing corresponding to the area surrounded by the chain line in FIGS. 2(d), 2(f), 2(g) and 2(f), and a liner stopper corresponding to the area surrounded by the chain line in FIGS. 2(b), 2(c) and 2(e), respectively. FIG. 4 is an enlarged cross-sectional view taken along the line IV-IV in FIGS. 2(b) to 2(h).

Each of the eight types of operating rods 8 different in internal structure as shown in FIGS. 2(a) to 2(h) can be incorporated in the portable brushcutter 2. These portable brushcutters 2 were subjected to vibration/vibration noise tests. Among the portable brushcutters 2 having the operating rods 8 illustrated in FIGS. 2(a) to 2(h), the portable brushcutters in FIGS. 2(e) to 2(h) are Inventive Examples, and the portable brushcutters in FIGS. 2(a) to 2(d) are Comparative Examples. In each of the operating rods illustrated in FIGS. 2(a) to 2(h), the right side corresponds to the side of drive unit 4, and the left side corresponds to the side of the cutting blade 6.

With reference to FIGS. 2(a) to 2(h), the respective structures of the operating rods 8 will be described below. The operating rod 8 illustrated in FIG. 2(a) (Comparative Example 1) is made of aluminum alloy 6061 (Al—Mg—Si alloy), and formed to have an outer diameter of 25 mm, a wall thickness of 1.2 mm and an entire length of 1500 mm. The operating rod 8 includes five bushings 20 disposed in the hollow space thereof while being spaced apart from each other to rotatably support the output shaft 16 (their positions are specified by the numbers (i) to (v) in order of the bushing 20 closer to the drive unit). The hollow space of the operating rod 8 is divided into six zones S₁ to S₆, each having approximately the same length in the longitudinal direction of the operating rod 8, and the bushings 20 are located, respectively, at the boundary positions (i) to (v) between adjacent ones of the six zones S₁ to S₆. Each of the bushings 20 is combined with an elastic member to have a vibration-insulating performance. Specifically, as shown in FIG. 3(a), each of the bushings 20 comprises a hollow cylindrical rubber member 19 in press contact with the inner surface 8a of the operating rod 8, and a bearing member 21 inserted in the hollow space of the rubber member 19 and coaxially formed with a hole 25. In these examples, the bearing member 21 is made of synthetic resin. Each of the bushings 20 has a longitudinal length of 20 mm.

In order to stably support the output shaft 16 over its entire length without wobbling movements to minimize vibrations caused by the rotation thereof, the number N of the bushings 20 is preferably set at four or more.

Among the bushings 20 illustrated in FIG. 2(a), the operating rod 8 illustrated in FIG. 2(b) (Comparative Example 2) includes three of the bushings 20 located, respectively, at the positions (i) to (iii). Further, this operating rod 8 includes a liner 22 which has an entire length of 450 mm and extends from the end of the operating rod 8 on the side of the cutting blade 6. With reference to FIG. 4, the structure of the liner 22 will be described below. The liner 22 is integrally molded into a single piece using a synthetic resin material capable of being elastically deformed adequately in response to impacts and vibrations acting on the operating rod 8 to absorb the impacts and vibrations. The liner 22 is formed with a through-hole 24 extending along the axis thereof to allow the output shaft 16 to pass therethrough. Further, the liner 22 has a plurality of strip-shaped faces circumferentially spaced apart from each other. Each of the strip-shaped faces extends in the longitudinal direction of the operating rod 8 while being in contact with the inner surface 8a of the operating rod 8. More specifically, the liner 22 has a cylindrical portion 28 formed with the through-hole 24 extending along the axis thereof and allowing the output shaft 16 to pass therethrough, and a plurality of convex strips (ribs) 30 each of which extends radially outward in the cross section from the outer peripheral surface of the cylindrical portion 28, and extends in the longitudinal direction of the cylindrical portion 28. The radially outermost face of each of the convex strips 30 serves as the strip-shaped face extending in the longitudinal direction of the operating rod 8 while being in contact with the inner surface 8a of the operating rod 8. The cylindrical portion 28 has a wall thickness of 2 mm, and each of the convex strips 30 has a wall thickness of 1.3 mm. The through-hole 24 is designed to have an inner diameter slightly greater than the outer diameter of the output shaft 16. In the operating rods used in the tests, the output shaft 16 had an outer diameter of 7 mm, and the through-hole 24 of the liner 22 had an inner diameter of 8 mm.

Returning to FIG. 2(b), a stopper 32 is disposed in the hollow space of the operating rod 8 to prevent the liner 22 from being moved in the longitudinal direction of the operating rod 8. The stopper 32 is made of rubber. As shown in FIG. 3(b), the stopper 32 is formed to have an outer diameter slightly greater than the inner diameter of the operating rod 8 to be held at a fixed position through press-fitting, and a hollow tubular shape with a through hole 33 extending along the axis thereof, The end 28a of the liner 22 on the side of the drive unit 4 has only the cylindrical portion 28 but not the convex strips 30. In this Example, this end 28a is designed to have the same length as that of the stopper 32. The inner surface of the through-hole 33 of the stopper 32 and the outer surface of the output shaft 16 are spaced apart from one another by a distance for receiving the cylindrical portion 28. The stopper 32 is press-fitted with the end 28a of the liner 22 on the side of the drive unit 4 to receive the cylindrical portion 28 of the liner 22 between the output shaft 16 and the stopper 32 so as to prevent the liner 22 from being moved in the longitudinal direction of the manipulations rod 8.

The operating rod 8 illustrated in FIG. 2(c) (Comparative Example 3) includes four of the bushings 20 located, respectively, at the positions (i) to (iv). Further, this operating rod 8 includes a liner 34 which has an entire length of 450 mm and extends from the end of the operating rod 8 on the side of the cutting blade 6. The liner 34 has the same structure as that of the liner in FIG. 2(b) and FIG. 4. The same stopper 32 as that in FIG. 3(b) is press-fitted with the end of the liner 34 on the side of the drive unit 4 at a position slightly spaced apart from the bushing 20 located at the position (iv) closest to the cutting blade 4, toward the cutting blade 6.

The operating rod 8 illustrated in FIG. 2(d) (Comparative Example 4) includes four of the bushings 20 located, respectively, at the positions (i) to (iv). Further, this operating rod 8 includes a liner 36 which has an entire length of 480 mm and extends from the end of the operating rod 8 on the side of the cutting blade 6. The liner 36 has the same structure as that of the liner in FIG. 4. The liner 36 extends from the end of the operating rod 8 on the side of the cutting blade 6 to the position (iv) closest to the cutting blade 4, and the bushing 20 located at the position (iv) prevents the liner 36 from being moved in the longitudinal direction of the operating rod 8.

The operating rod 8 illustrated in FIG. 2(e) (Inventive Example 3) includes all or five of the bushings 20 located, respectively, at the positions (i) to (v). The hollow space of the operating rod 8 is divided into six zones S₁ to S₆, each having substantially the same length in the longitudinal direction of the operating rod 8, and these bushings 20 are located, respectively, at the boundary positions (i) to (v) between adjacent ones of the 1st to 6th zones S₁ to S₆, in turn, from the side of the drive unit 4. Further, this operating rod 8 includes a liner 38 which has an entire length of 210 mm and extends from the end of the operating rod 8 on the side of the cutting blade 6. The liner 38 has the same structure as that of the liner in FIG. 4. In a similar manner to the stopper in FIG. 2(c), the same stopper 32 is press-fitted with the end of the liner 38 on the side of the drive unit 4 at a position slightly spaced apart from the bushing 20 located at the position (v) closest to the cutting blade 4, toward the cutting blade 6. The detailed structure of the stopper 32 is the same as that in FIG. 3(b).

The operating rod 8 illustrated in FIG. 2(f) (Inventive Example 1) includes five of the bushings 20 located, respectively, at the positions (i) to (v). The hollow space of the operating rod 8 is divided into six zones S₁ to S₆, each having substantially the same length in the longitudinal direction of the operating rod 8, and these bushings 20 are located, respectively, at the boundary positions (i) to (v) between adjacent ones of the 1st to 6th zones S₁ to S₆, in turn, from the side of the drive unit 4. Further, this operating rod 8 includes a liner 40 which has art entire length of 230 mm and extends over the 6th zone (S₆) closest to the cutting blade 6. The liner 40 has the same structure as that of the liner in FIG. 4. The liner 40 extends from the end of the operating rod 8 on the side of the cutting blade 6 to the position (v), and the bushing 20 located at the position (v) prevents the liner 40 from being moved in the longitudinal direction of the operating rod 8.

The operating rod 8 illustrated in FIG. 2(g) (Inventive Example 2) includes five of the bushings 20 located, respectively, at the positions (i) to (v). The hollow space of the operating rod 8 is divided into six zones S₁ to S₆, each having substantially the same length in the longitudinal direction of the operating rod 8, and these bushings 20 are located, respectively, at the boundary positions (i) to (v) between adjacent ones of the 1st to 6th zones S₁ to S₆, in turn, from the side of the drive unit 4. Further, this operating rod 8 includes a liner 42 which has an entire length of 230 mm and extends over the 6th zone (S₆) closest to the cutting blade 6. The operating rod 8 also includes a liner 44 which has an entire length of 230 mm and extends over the 5th zone (S₅) between the respective bushings 20 located at the position (v) and the position (iv). Each of the liners 42, 44 has the same structure as that of the liner in FIG. 4. The liner 42 extends from the end of the operating rod 8 on the side of the cutting blade 6 to the position (v), and the liner 44 extends between the position (v) and the position (iv). Thus, the bushings 20, 20 located at the positions (v), (iv) prevent the liners 42,44 from being moved in the longitudinal direction of the operating rod 8.

Except that a liner 46 having an entire length 230 mm is provided only in the 5th zone (S₅) but no liner is provided in the 6th zone (S₆). the operating rod 8 illustrated in FIG. 2(h) (Inventive Example 4) has the same structure as that of the operating rod 8 illustrated in FIG. 2(g). Thus, the detailed description will be omitted.

### 1-2. Test Process

The portable brushcutters 2 having the above eight types of operating rods 8 were subjected to vibration/vibration noise tests. The vibration test was performed by attaching an accelerometer to the grip 10 on the side of the cutting blade 6 and to the grip 12 on the side of the drive unit 4, increasing the speed of the internal combustion engine 14 from an idling speed (about 3000 rpm) up to a full throttle speed (about 11000 rpm), and measuring a maximum value of acceleration in a torsional direction. It was also checked whether vibration noise is generated during the vibration test.

### 1-3. Test Results and Evaluation

FIG. 5 shows the result of the vibration/vibration noise tests. In respect to the test on only vibration, the test results of Examples illustrated in FIG. 2(b) to 2(h) were evaluated on the basis of the operating rod having no liner (Comparative Example 1) illustrated in FIG. 2(a). While Comparative Example 3 illustrated in FIG. 2(c) and Inventive Examples 1 and 2 illustrated in FIGS. 2(f) and 2(g) had approximately the same vibration value in the grip 10 on the side of the cutting blade 6 as that of Comparative Example 1, they had a lower vibration value in the grip 12 on the side of the drive unit 4 than that of Comparative Example 1.

While Comparative Example 4 illustrated in FIG. 2(d) had approximately the same vibration value in the grip 10 on the side of the cutting blade 6 as that of Comparative Example 1, it had a lower vibration value in the grip 12 on the side of the drive unit 4 than that of Comparative Example 1.

While Inventive Examples 3 and 4 illustrated in FIG. 2(e) and 2(h) had approximately the same vibration value in the grip 12 an the side of the drive unit 4 as that of Comparative Example 1, they had a higher vibration value in the grip 10 on the side of the cutting blade 6 than that of Comparative Example 1.

While Comparative Example 2 illustrated in FIG. 2(b) had approximately the same vibration value in the grip 12 on the side of the drive unit 4 as that of Comparative Example 1, it had a fairly higher vibration value in the grip 10 on the side of the cutting blade 6 than that of Comparative Example 1.

### 1-4. Comprehensive Evaluation on Vibration and Vibration Noise

The result of the vibration noise test was as follows.

While Comparative Example 1 illustrated in FIG. 2(a) and Inventive Examples 1 to 4 illustrated in FIGS. 2(e) to 2(h) generated no noise, Comparative Examples 2 to 4 illustrated in FIGS. 2(b) to 2(d) generated noises, and particularly Comparative Example 2 generated a large amount of noise.

Through a comprehensive evaluation in combination with the above results of the vibration/vibration tests, the result as shown in the left column of FIG. 5 was obtained. Specifically, Inventive Examples 1 and 2 had the best result. Further, comparing Inventive Example 1 having only the liner 40 provided in the 6th zone S₆, and Inventive Example 2 having the two liners 42, 44 provided in both the 6th zone S₆ and 5th zone S₅, Inventive Example 1 is more desirable in view of weight reduction. Thus, in view of all factors of vibration, vibration noise and weight, Inventive Example 1 illustrated in FIG. 2(f) had the best result.

### 2. STRENGTH TEST (IMPACT TEST)

### 2-1. Structure of Operating Rod

An operating rod 8 having the same structure as that illustrated in FIG. 2(c) was subjected to an impact test. However, differently from the liner 34 in Comparative Example 3 having a length of 450 mm, a liner used in the strength test had a length of 410 mm. Except for the length of the liner, the liner was designed to have the same structure as that illustrated in FIG. 2(c). For example, the end of the liner on the side of the drive unit 4 was held by the aforementioned stopper 32 in the same way.

As to the material of the operating rod 8 (outer tube), while all of Examples illustrated FIGS. 2(a) to 2(h) were made of aluminum alloy (6061), each of the operating rods 8 as Sample Nos. 1 and 2 for the strength test was made of aluminum alloy (6063), and each of the operating rods as Sample Nos. 3 and 7 for the strength test was made of aluminum alloy (6061).

As to the wall thickness of the operating rod 8 (outer tube), each of the operating rods as Sample Nos. 1, 2, 5 and 6 was set at 1.5 mm, and each of the operating rods as Sample Nos. 3 and 4 was set at 1.2 mm. Further, the operating rods as Sample No. 7 was set at 2 mm.

### 2-2. Strength Test

Each of the above operating rods 8 having a length 1500 mm was supported at two positions located away from its respective opposite ends by 50 mm. After 8 kg of weight W is attached to the front end of an iron bar having a diameter of 22 mm, the iron bar was swingably supported by a universal joint attached thereto at a position located away from the front end by a length L of 1100 mm. Then, the iron bar was positioned in such a manner that a portion of the iron bar located away from the front end by 300 mm can serve as an impact point to be brought into collision with the longitudinal center point between the two support positions of the operating rod 8.

The iron bar was swung downward from each of different angles (é) of 30, 60, 90 and 120 degrees, and brought into collision with each of the different operating rods 8, to give a given impact value J=WX♦LX (1−cos (é)) to them. Then, the resulting deformation angle (permanent bent angle) of each of the operating rods 8 was measured. A 180-degree of deformation angle means that the operating rod is maintained in its linear shape without deformation.

### 2-3. Result of Strength Test

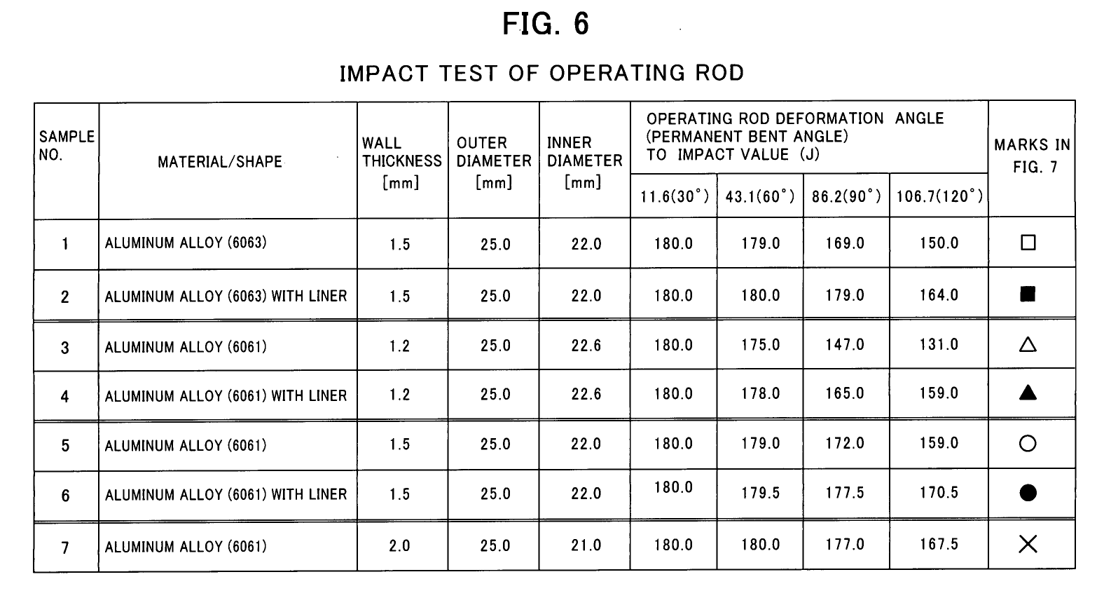

FIG. 6 shows the result of the impact test.

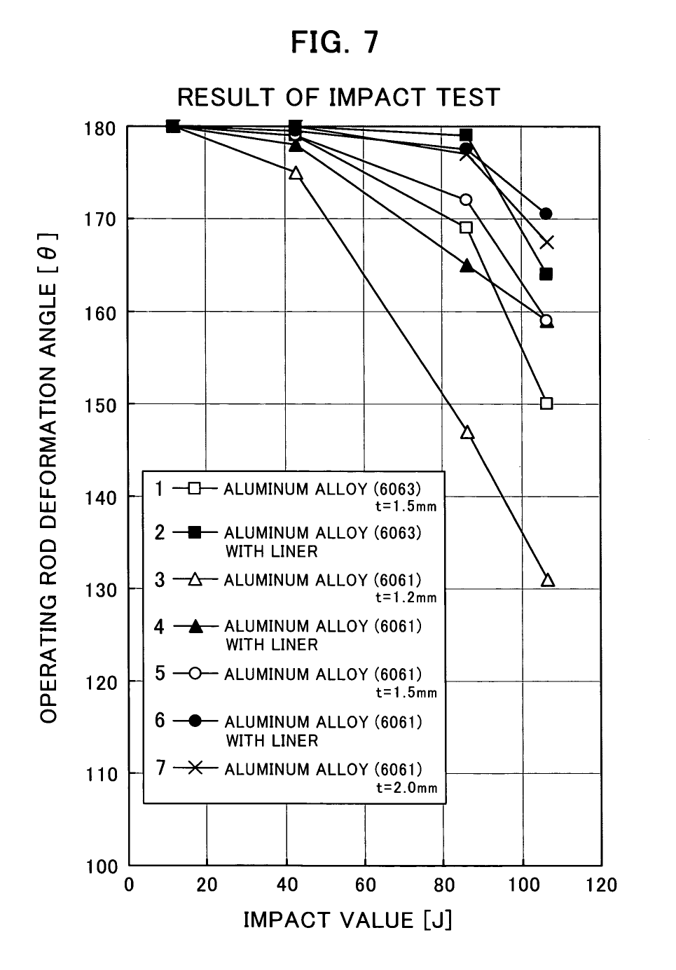

FIG. 7 is a graph of the test result in FIG. 6, which shows the relationship between the impact value J and the deformation angle (permanent bent angle) of each of the operating rods 8.

In the marks used in the graph of FIG. 7, the white marks indicate the operating rods 8 devoid of liner, and the black marks indicate the operating rods 8 having the same structure and the aforementioned liners. As seen in FIG. 7, in either of the operating rods 8 different in material and/or dimension, the operating rod having the liner on the side of the cutting blade has less deformation. This means that the bending strength of the entire operating rod 8 cart be improved by providing the liner on the side of the front end of the operating rod 8.

Comparing between the respective test results, the operating rod 8 formed using a material of aluminum alloy 6061 to have a wall thickness of 1.2 mm and provided with the liner in the hollow space of the outer tube (indicated by in FIG. 7) had a strength equivalent to those of the operating rod 8 formed using a material of aluminum alloy 6061 to have a wall thickness of 1.5 mm and provided with no liner (indicated by in FIG. 7) and the operating rod 8 formed using a material of aluminum alloy 6063 to have a wall thickness of 1.5 mm and provided with no liner (indicated by in FIG. 7).

The operating rod 8 formed using a material of aluminum alloy 6061 to have a wall thickness of 1.5 mm and provided with the liner in the hollow space of the outer tube (indicated by in FIG. 7) has a strength equivalent to the operating rod 8 formed using a material of aluminum alloy 6061 to have a wall thickness of 2.0 mm and provided with no liner (indicated by x in FIG. 7).

### 3. COMPREHENSIVE EVALUATION

In view of all factors of vibration, vibration noise, weight and strength, it was judged that Inventive Example 1 illustrated in FIG. 2(f) provide an optimal effect.

It is understood that the present invention is not limited to the above specific examples, but various modifications may be made without departing from the sprit and scope of the present invention as set forth in the appended claims, and it is intended that such modifications are also encompassed within the scope of the present invention.

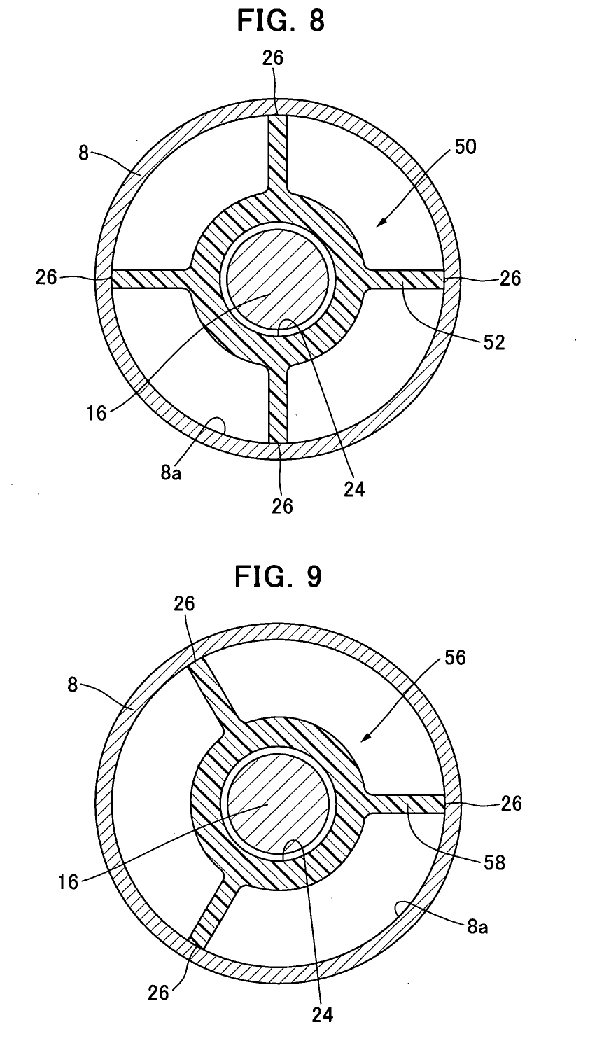

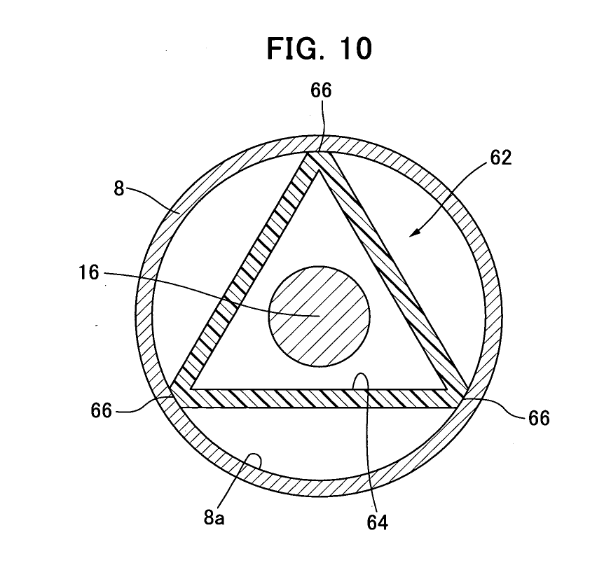

For example, while the liner illustrated in FIG. 4 has the five radially-extending convex strips, the liner may be formed in any other suitable configuration which has a through-hole 24 extending along the axis thereof to allow the output shaft 16 to pass therethrough, and a radially outermost periphery formed as a plurality of strip-shaped faces spaced apart from each other and brought into contact with the inner surface 8a of the operating rod 8. For example, it may have a configuration as shown in FIGS. 8 to 10. Specifically, instead of the five radially-extending convex strips in the aforementioned liner 22, 34, 36, 38, 40, 42, 44, 46 illustrated in FIG. 4, a liner 50 in FIG. 8 has four radially-extending convex strips 52 circumferentially spaced apart from each other (about 90-degree interval). Alternatively, a liner 56 in FIG. 9 has three radially-extending convex strips 58 circumferentially spaced apart from each other (about 120-degree interval). Except for these points, the liners 50, 56 have the same structure as that of the liner in FIG. 4. Further, a liner in FIG. 10 is a triangular-shaped hollow tube 62 having a cross-sectionally triangular-shaped through-hole 64 formed therein to allow the output shaft 16 to pass therethrough. This liner 62 has a radially outermost periphery formed as three strip-shaped faces 66 defined by the respective apexes of the triangle, each of which extends in the longitudinal direction of the operating rod 8 while being in contact with the inner surface 8a of the operating rod 8.

The cross-sectional shape of the through-hole formed in the liner to extend along the axis thereof is not limited to a specific shape, such as the circular shape in FIGS. 8 and 9 or the triangular shape in FIG. 10, but the through-hole may have any suitable cross-sectional shape allowing the output shaft to pass therethrough.

Further; the strip-shaped faces may be formed in any suitable shape circumferentially spaced apart from each other in the cross section of the liner. The spaces be formed between the slip-shaped faces can be effectively utilized to minimize the weight of the portable brushcutter 2, and to obtain anti-vibration/vibration-noise effects and desired impact/shock absorbing performance.

Furthermore, the stopper 32 may have any suitable configuration or mechanism capable or preventing the liner from being moved in the operating rod 8 in its longitudinal direction.

1. A portable brushcutter comprising:
a cutting blade;
a drive unit;
a hollow tubular operating rod having a front end provided with said cutting blade, and a rear end provided with said drive unit;
an output shaft for transmitting a driving force from said drive unit to said cutting blade, said output shaft being disposed in the hollow space of said operating rod to extend in the longitudinal direction of said operating rod;
at least four bushings each having an elastic member, said bushings being disposed in the hollow space of said operating rod while being spaced apart from each other in the longitudinal direction of said operating rod, to support said output shaft, said bushings being located, respectively, at the boundaries between adjacent ones of a plurality of zones defined by dividing the hollow space of said operating rod in the longitudinal direction from the side of said drive unit to the side of said cutting blade;
a liner extending within only one or more of the zones located on the side of said cutting blade, said liner being formed with a through-hole extending along the axis thereof to allow said output shaft to pass therethrough, said liner having a radially outermost periphery formed as a plurality of strip-shaped faces circumferentially spaced apart from each other, each of said strip-shaped faces extending in the longitudinal direction of said operating rod while being in contact with the inner surface of said operating rod.

2. The portable brushcutter as defined in claim 1, wherein said liner extends along the entire range of the zone closest to said cuffing blade.

3. The portable brushcutter as defined in claim 1, wherein said liner extends along both the zone closest to said cutting blade and the zone adjacent to said zone closest to said cutting blade.

4. The portable brushcutter as defined in claim 2, wherein said liner extends along both the zone closest to said cutting blade and the zone adjacent to said zone closest to said cutting blade.

5. The portable brushcutter as defined in claim 1, wherein the number of said bushings is five.

6. The portable brushcutter as defined in claim 2, wherein the number of said bushings is five.

7. The portable brushcutter as defined in claim 3, wherein the number or said bushings is five.
